(19) United States
(12) Patent Application Publication
(10) Pub. No.: US 2016/0279914 A1
(43) Pub. Date: Sep. 29, 2016

(54) Elastic Floor Panel

(71) Applicant: WPT GMBH, Detmold (DE)

(72) Inventors: Stefan Rose, Warstein (DE); Guido Horst, Bünde (DE); Ulrich Windmöller, Schloss Holte-Stukenbrock (DE)

(21) Appl. No.: 15/028,193

(22) PCT Filed: Oct. 11, 2013
(86) PCT No.: PCT/EP2013/071277

§ 371 Date: Apr. 8, 2016

(51) Int. Cl. B32B 27/40; E04F 15/02; B32B 38/00; E04F 15/10; B32B 27/12; B32B 37/12

(52) U.S. Cl. CPC B32B 27/40; B32B 27/12; B32B 37/12; B32B 38/0004; E04F 15/107; E04F 15/102; E04F 15/02183; B32B 2471/00; B32B 2307/554; B32B 2262/101

(57) ABSTRACT

An elastic floor panel (10), includes a dimensionally stable core (18) of polyurethane and a layered compound structure (24), which is disposed on the core (18), and the back of the floor panel (10) is coated with a fiber mat (20), the fibers of which consist of glass, PET, PP, polyester or renewable raw materials, and which is sealed on the side facing the core by a barrier layer.

The present invention relates to an elastic floor panel, with a dimensionally stable core of polyurethane and a layered compound structure disposed on the core.

Floor coverings, which are assembled from floor panels, have been assembled for some time from very different materials. Traditionally, floor panels from wood or wood materials, such as MDF or HDF, are known, which are provided with connecting profiles for engaging the respectively adjoining panel. On their upper side, these panels usually have a decorative layer and a wear resistant use surface, while a counterpull layer is present on the back.

Moreover, floor panels are known, which are produced from plastic materials such as PVC. Polyurethane is also suitable as a material for such floor panels. For example, from the international patent application WO2013/064160 of the Applicant, a floor covering is known, for which at least the core consists of a polyurethane, which is obtained from a polyester polyol of renewable raw materials and an aromatic isocyanate. This entails, among other things, advantages with respect to environmental compatibility. In this case also, a decorative layer and a wear-resistant use layer are disposed on the core. Within the scope of the present invention, the layers on the core generally are referred to as a layered compound structure, it being noted that this layered compound structure may also be arranged differently and, for example, may comprise additional layers or layers of a different type. The concept used here of a layered compound structure accordingly is not limited to, the sequence of layers, which is described in WO2013/064160.

Such a floor covering can be cut into panels, which are provided with connecting profiles at the edges. However, it is also possible to omit profiling at the edges and to lay the panels by gluing them, mutually adjoining, on the screed. It is advantageous if the floor panels have a certain elasticity, since this leads to positive use properties, such as a good footsteps sound insulation, a good impression behavior under loads and a force reduction with regard to sport functional properties. However, the polyurethane core is dimensionally stable, that is, although it may be deformed elastically, it retains its panel shape if the external load is not excessive, so that the floor panel as a whole can be handled as a stable entity, in contrast to floor coverings, which are in the form of sheets that can be rolled up.

If a floor panel can be glued reliably over its whole surface to the substrate, its back must be able to form a good bond with the adhesive. For this purpose, it was previously customary to grind the back of the floor panels or to provide them with a surface structure, such as a honeycomb structure or the like, into which the adhesive can penetrate well. In spite of these additional measures, the bond between the dispersion adhesive and the back of the floor panel frequently is not satisfactory.

Furthermore, it is also desirable to improve the above-mentioned positive properties of the floor panel further by designing its back appropriately. For example, it is possible to improve the footstep sound insulation and also the introduction of forces into the floor panels, which are used as sports flooring. These improvements also to come into effect, if the floor panels are not glued to a substrate, as described above, but are only placed loosely and with mutually engaging edge profiles.

It is therefore an object of the present invention to create a floor panel, which, if required, can be glued reliably to a substrate and the properties of which, especially the floor step sound insulation and the elasticity, are improved further.

Pursuant to the invention, this objective is accomplished by an elastic floor panel with the features of claim 1.

The elastic floor panel of the present invention is coated on its back with a fiber mat, the fibers of which consist of glass, PET, PP, polyester or renewable raw materials. On the side, facing the core, the fiber entity of the mat is sealed by a barrier layer.

A liquid adhesive, which has been applied on this screed, can penetrate between the fibers of the mat, so that the adhesive and the fiber mat and, accordingly, the whole of the floor panel can be connected uniformly with one another. This connection is far more reliable than that of floor panels, the underside of which has merely been ground or which have embossing on their back. It is no longer possible to raise the floor panel nondestructively. The barrier layer ensures that, during the manufacturing process of the floor panel, the fiber mat can be laminated or glued to its back without the interstices between the fibers being filled or glued by an adhesive or the material of the core, depending on the manufacturing process. Accordingly, a liquid material can be applied on the fiber mat during the manufacturing process, without the desired properties of the mat being affected by the use of said material.

Because of the comparative loose cohesion of its fibers, the fiber mat may have a certain elasticity, which has a positive effect on the overall properties of the floor panels and, moreover also, when the floor panel is laid loosely, that is, without gluing. For example, the footsteps sound insulation can be improved as can also the introduction of forces into the floor panels, which are used as sport floors. Finally, the fiber mat can also form a counterpull layer to the layered compound structure on the upper side of the floor panel.

On the whole, the inventive floor panel represents a complex layered entity, which has improved properties, and at the same time can be laid more reliably and permanently than the floor panels, which are described above as prior art.

In accordance with a preferred embodiment of the present invention, the fibers of the fiber mat form a nonwoven.

In accordance with a further preferred embodiment, the fibers are interwoven into a fabric mat.

In both cases, interstices may remain between the fibers, into which the liquid adhesive can penetrate and thus enter into the desired bond with the floor panel.

In accordance with a further preferred embodiment, the fiber mat is glued to the back of the core. The adhesive, used for this purpose, does not penetrate into the fiber mat, since this is prevented reliably by the barrier layer. Accordingly, the interstices between the fibers remain for taking up the adhesive for gluing the floor panel to the screed.

In accordance with a further preferred embodiment, the barrier layer is formed from polyolefin, polyethylene terephthalate (PET), polyamide (PA) or a thermoplastic polyurethane (TPU).

The core furthermore, preferably consists of a polyurethane, which is obtained from a polyester polyol of renewable raw materials and an aromatic isocyanate. It is a question here of a biogenic polyol, which has good properties with regard to environmental compatibility and can be produced sustainably.

In accordance with a further preferred embodiment of the present invention, the layered compound structure of the floor panel, which is disposed on the core, comprises at least one decorative layer, which consists of fiber paper, which is impregnated with a polyurethane, a wear-resistant use layer, which is on the side of the decorative layer averted from the core and comprises a polyurethane, which is obtained from a polyol and an aliphatic isocyanate, and a fiberglass mat. The fiberglass mat can improve the impression behavior and the recovery behavior as well as the dimensional stability even further.

In accordance with a further preferred embodiment, the inventive floor panel is profiled at least at two opposite outer edges. By these means, connecting profiles may be created, which hold two adjacently laid floor panels together.

Furthermore, preferably, the core contains fillers for increasing the weight. In this case, therefore, the core does not consist exclusively of pure polyurethane; instead, mineral fillers, for example, which have a higher specific gravity than the polyurethane, are added to the polyurethane composition, for forming the core.

An inventive method for producing a floor panel of the type described above, comprises the following steps:
a) depositing a fiber mat sheet, which is formed from fibers of glass, PET, PP, polyester or renewable raw materials and is sealed on one side by a barrier layer, on a carrier strip in such a manner, that the barrier layer is at the top;
b) applying a layer of a polyurethane composition on the fiber mat sheet for forming the core, which contains polyurethane composition, polyurethane and optionally fillers.
c) applying an adhesive on the upper side of the core;
d) gluing a sheet-shaped layered compound structure to the upper side of the core, which is provided with adhesive;
e) cutting the sheet, produced in step d), into floor panels.

In the above-mentioned step a), the fiber mat sheet may be deposited, for example, on a conveyor belt, which passes over a hot plate. The polyurethane layer, which is applied on the fiber mat in step b) for forming the core, may be reacted fully by the action of the heat of the hot plate. Because of the barrier layer of the fiber mat, the polyurethane, which is applied in the liquid state, cannot penetrate between the fibers of the fiber mat sheet below, so that the interstices between the fibers are retained. The layered compound structure, which is glued on in step d), may be present in an already prefabricated state. Finally, by the cutting in step e), the floor panel is produced, the dimensions of which are suitable for the laying and which is dimensionally stable, that is, which retains its panel shape unless acted upon by larger external forces. For example, like conventional floor panels of wood materials or plastic, these floor panels can be stacked and may be transported in appropriate packages.

In accordance with an alternative embodiment of the present invention, the method for producing a floor panel comprises the following steps:
a′) depositing a sheet-shaped layered compound structure on a carrier strip;
b′) applying a layer of a polyurethane composition on the sheet-shaped layered compound structure for forming the core, which contains a polyurethane composition, polyurethane and optionally fillers
c′) applying an adhesive on the upper side of the core;
d′) gluing a fiber mat sheet, which consists of fibers of glass, PET, PP, polyester or renewable raw materials and is sealed on one side by a barrier layer, on the upper side of the core, which is provided with adhesive, in such a manner that the barrier layer is at the bottom;
e′) cutting the sheet, produced in step d′) into floor panels.

For this alternative method, the layers are produced in the reverse sequence in that initially the layered compound structure, which, in the laid state, forms the upper side of the floor panel, is deposited in step a′) with the use side downward on the carrier strip and the further layers are applied sequentially up to the fiber mat sheet, which is glued on in step d′) and forms the back of the floor panel. Here, the barrier layer of the fiber mat sheet prevents the adhesive, which is applied on the upper side of the core in step c′), penetrating between the fibers and gluing these together.

The polyurethane composition, which is used in steps d) or b′) to form the core, may be a pure polyurethane or a polyurethane, which is provided with aggregates or fillers. Typically, the fillers, the specific gravity of which is higher than that of polyurethane, are intended to increase the weight here also.

Preferably, heat is supplied to the polyurethane layer during or after the above-named steps c) or c′) to form the core. This may be accomplished, for example, by the already mentioned hot plates under the carrier strip. Alternatively, however, it is also possible to have infrared radiation act from above on the polyurethane layer.

In this case, the fiber mat sheet, preferably is a nonwoven.

Furthermore preferably, the fiber mat sheet is a woven fabric sheet.

In accordance with a further preferred embodiment, the floor panels, after being cut to size in step e) or e′), are profiled at least at two opposite outer edges.

In the following, preferred examples of the present invention are explained in greater detail by means of the drawing.

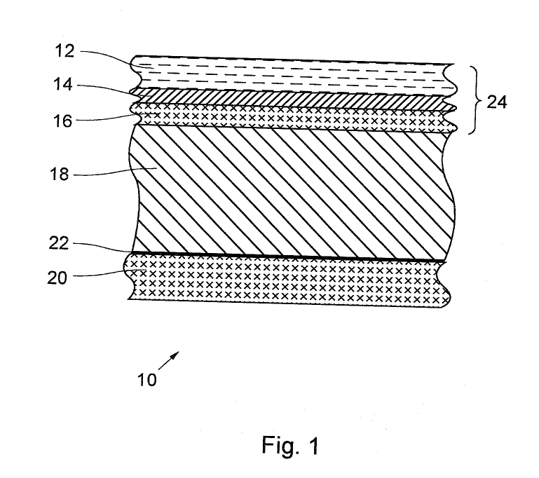

FIG. 1 shows a diagrammatic section through the layer construction of an embodiment of the inventive elastic floor panel and

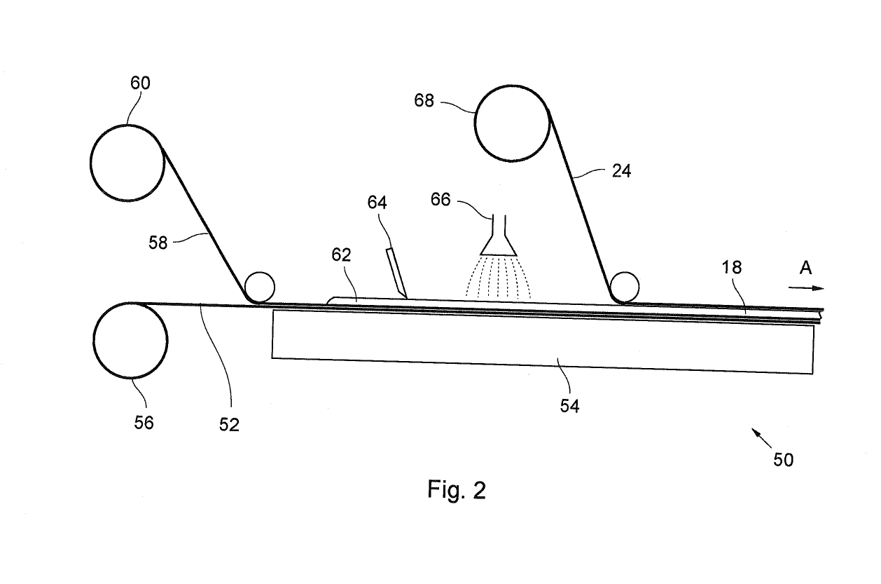

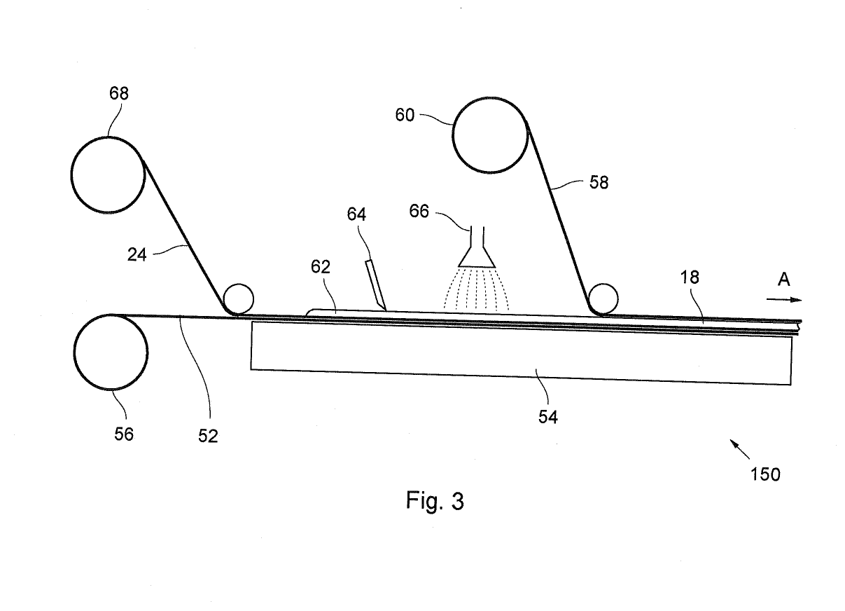

FIGS. 2 or 3 are diagrammatic representations of two different process sequences for producing the inventive elastic floor panel.

FIG. 1 shows a cross-section through an elastic floor panel 10, which has a layer construction. This comprises (from the top to the bottom, that is, from the use side to the back) a transparent, wear-resistant use layer 12, which forms the upper side of the floor panel 10, a decorative layer 14 below, which has a decoration, a fiberglass mat 16 under the decorative layer 14, a core 18 and a fiber mat 20, which completes the layered construction of the floor panel 10 in the direction of the substrate. Details of this layered construction are to be described in greater detail in the following.

The wear-resistant use layer 12 consists completely of a polyurethane (PU), which is obtained from a polyol and an aliphatic isocyanate. In the present case, this polyol is not a biogenic polyol and, accordingly, it does not originate from renewable raw materials. Furthermore, the wear-resistant use layer 12 has a high abrasion resistance, is readily cleaned, is UV resistant, has a good impression and restoring behavior and emits only a small amount of toxic gases in the event of a fire. The impression behavior is understood to be the behavior of the material when subjected to a mechanical load. The surface of the floor panel 10 is very resistant to such effects. In the event that impressions are formed, for example, by an intermittent stress, these are reduced almost completely when the mechanical load is removed.

For the present embodiment, the wear-resistant layer 12 has a thickness of 0.1 to 0.5 mm.

The decorative film 14 below the wear-resistant layer 12 consists of a decorative paper, namely a layer of cellulose, which is impregnated with polyurethane. This polyurethane may be synthesized from a biogenic polyol, which is obtained from a renewable raw material. A decor is printed on the upper side of the decorative paper.

To increase the dimensional stability and to improve the impression and restoring behavior of the floor panel 10 further, the layer structure furthermore comprises a fiberglass mat 16, which is disposed between the decorative layer 14 and the core 18 below the decorative layer 14. This fiberglass mat is also impregnated with a polyurethane, which is produced from a biogenic polyol. It has a thickness of between 0.2 mm and 0.5 mm.

In the present case, the core 18 comprises a polyurethane, which is obtained from a polyester polyol of renewable raw materials and an aromatic isocyanate. Admittedly, the quality of an aromatic isocyanate is less than that of an aliphatic isocyanate; however, since the core 18 is not exposed on the upper side of the floor panel 10, the use of materials, which are of a lower quality, is also acceptable here. Nevertheless, the core 18 has very good properties with respect to environmental compatibility and produces very little in the form of emissions.

The core 18 is semi-hard, can thus be compressed elastically, but is dimensionally stable in the stress-free state. This means that the core 18, and, with that, the whole of the floor panel 10 largely retains its panel shape when handled, slight deflections of the floor panel 10 under their own weight having to be accepted. This dimensional stability makes it possible to handle the inventive, elastic floor panel 10 like any other conventional floor panel of plastic or wood materials, that is, it can be laid like usual floor panels or floor tiles. Accordingly, the inventive floor panel 10 combines the advantages of the previous floor panels with respect to handling and laying, with the advantages of an elastic floor covering, especially with regard to footsteps sound insulation and the introduction of forces into the floor covering.

The floor panel 10, presented here, can be glued onto a screed by means of a dispersion adhesive, so that floor panels 10, arranged next to one another, form the floor covering. For this purpose, the back of the floor panels 10 includes a fiber mat 20, which may, for example, be a nonwoven mat. It is, however, also conceivable to use a fabric mat as a fiber mat 20. A liquid dispersion adhesive, which was previously distributed on the screed, can penetrate between the fibers. In this way, a firm bond between the substrate and the elastic floor panel 10 is created. The floor panel 10 can then no longer be removed nondestructively from the substrate.

The fibers of the fiber mat 20 may, for example, be glass fibers or consist of PET (polyethylene terephthalate), PP (polypropylene), polyester or also of renewable raw materials, that is, natural fibers. On the side, which faces the core 18 and is at the top in FIG. 1, the fiber mat 20 is sealed by a barrier layer 22 of polyolefin. The barrier layer 22 may, however, also consist of other materials, such as polyethylene terephthalate (PET), polyamide (PA) or thermoplastic polyurethane (TPU). One of the functions of the barrier layer 22 is to prevent liquids from penetrating from the upper side of the floor panel 10 into the fiber mat 20 and, with that, fill the interstices between the fibers. This is of importance for the production of the elastic floor panel 10. In particular, the fiber mat 20 may, for example, be glued with the help of a liquid adhesive to the back of the core 18. Accordingly, penetration of this adhesive between the core 18 and the fiber mat 20 between the fibers can be prevented by the barrier layer 22.

Aside from the function of taking up the adhesive for gluing the floor panel 10, the fiber mat 20 may, moreover, also have still further functions, which have an effect on the quality of the floor panel 10. For example, the fiber mat 20 may form a counterpull layer on the underside of the floor panel 10 and contribute to the dimensional stability of the latter. Furthermore, because the fibers are bonded relatively loosely, the fiber mat 20 may have a certain elasticity when subjected to pressure loads, which is also retained if the adhesive does not penetrate completely into the fiber mat 20 from the substrate and an adhesive free intermediate layer remains within the fiber mat 20, the hollow spaces of which improve the elastic properties. The footsteps sound behavior and the introduction of forces into the substrate can also be improved by these means. These improvements have an effect also, when the floor panel 10 is laid loosely, that is, without adhesive, on the substrate.

As described above, several floor panels 10 may be laid next to one another on the substrate. In addition, the individual floor panels 10 may be profiled at their outer edges and thus include connecting profiles, by means of which mutually adjoining floor panels can be connected with one another positively. The floor panels 10 can then no longer be shifted accidentally with respect to one another.

The wear-resistant use layer 12, the decorative layer 14 and the fiberglass mat 16 may jointly form a layered compound structure, which may be prefabricated prior to a process of manufacturing the above-described floor covering 10, while the remaining layers, that is, especially the core 18 and the fiber mat 20 are connected only subsequently with this compound layered structure 24. This is to be described in detail in the following.

FIG. 2 is a diagrammatic representation of a first embodiment of a method for producing the elastic floor panel 10 of the type described above. This Figure shows a portion of a production plant, with the help of which this process is carried out. The plant comprises a carrier strip 52, which is passed in FIG. 2 from left to right in the direction of the arrow A over a hot plate 54.

The carrier strip 52 lies flat on the upper side of the hot plate 54. It may be an endless belt here, the tight side of which is passed over the hot plate 54 or the carrier strip 52 is unwound from a roll 56 and rolled up again at the end of the production line (not shown). A fiber mat sheet 58, which is unwound from a roll 60, is deposited flat on a section of the carrier strip 52, which rests on the hot plate 54. In its design, this fiber mat sheet 58 corresponds to the design of the fiber mat 20, which is described in connection with FIG. 1, that is, the fiber mat sheet 58 is formed from fibers of glass, PET, PP, polyester or renewable raw materials and is sealed on one side by a barrier layer 22 of polyolefin, polyethylene terephthalate (PET), polyamide (PA) or thermoplastic polyurethane (TPU). This barrier layer 22 in FIG. 2 is at the top, that is, on the upper side of the fiber mat sheet 58, which is averted from the carrier strip 52 and, moreover, may alternately be formed from a nonwoven or also as a fabric mat.

In a subsequent step of the process, a layer 62 of a polyurethane composition, which is to form the core 18, is deposited on the fiber mat sheet 58. This composition is poured or sprayed in liquid form onto the fiber mat sheet 58. The thickness of the layer 62, which can be checked by suitable measuring devices (not shown), is determined by a doctor blade 64. This polyurethane composition may consist exclusively of pure polyurethane. It may, however, also contain fillers or other aggregates, such as, for example, mineral fillers, the specific gravity of which is higher than that of the polyurethane and which are to contribute to an increase in weight of the floor panel 10, which is to be produced.

The liquid polyurethane composition completes its reaction under the action of heat, so that the layer 62 is cured. The heat is supplied by the hot plate 54 under the carrier strip 52 and acts through the carrier strip 52 and the fiber mat sheet 58 on the layer 62. The production of the core 18 is completed after the layer 62 has reacted fully. Subsequently, in a further step of the process, an adhesive can be applied to the upper side of the core 18. The adhesive need not be applied continuously over the whole surface, but can also be sprayed on in the form of fine droplets. For this purpose, a turntable 66, for example, which is disposed above the core 18 and sprays liquid adhesive radially, may be used, so that an approximately uniform distribution of the adhesive droplets on the core 18 is achieved.

In a further step of the process, a sheet-shaped layered compound structure 24 is applied on and glued to the core 18. This layered compound structure 24 may comprise, in the manner described above, the wear-resistant use layer 12, the decorative layer 14 and the fiberglass mat 16 of FIG. 1. The layered compound structure 24 is delivered in a prefabricated form and unwound from a roll 68 and deposited on the upper side of the core 18, which has been provided with the adhesive.

The sheet, produced by the steps of the process described above, after being fully reacted, forms a continuous panel, which, in a further step of the process, is cut into individual floor panels 10, that is, the dimensionally stable sheet, which has resulted, is divided sectionwise in the transverse and longitudinal directions. In addition, it is furthermore possible to profile the outer edges of the floor panels, produced in this manner, in order to create connecting profiles for engaging an adjacent floor panel. The profiling may be accomplished by milling and may comprise several individual profiling steps, in which different milling tools are used.

Alternatively to the method described above by means of FIG. 2, it is possible to build up the floor panel 10, to some extent, in the reverse sequence. This is to be described in the following by means of FIG. 3.

The production plant 150 in FIG. 3 also comprises a carrier strip 52, which is unwound from a roll 60 and passed flat over a horizontal hot plate 54. In this respect, the plant 150 of FIG. 3 is identical with the plant 50 of FIG. 2. The sheet-shaped layered compound structure 24 is deposited on the upper side of this carrier strip 52; it is dispensed from a roll 68, so that it rests flat on the upper side of the carrier strip 54 and is passed, together with the latter, over the hot plate 54 in the direction of arrow A. Here also, the sheet-shaped layered compound structure 24 once again comprises the wear-resistant use layer 12, the decorative layer 14 and the fiberglass mat 16, and is deposited on the carrier strip 52, so that the wear-resistant use layer 12 is at the bottom and the fiberglass mat 16 is at the top.

Subsequently, a layer 62 of a liquid polyurethane composition for forming the core 18 is applied on the deposited sheet-shaped layered compound structure 24. In this case also, the polyurethane composition may consist of a pure polyurethane or contain additional fillers, as described above. This layer 62 is limited to the desired thickness by means of a doctor blade 64. The layer 62 may be cured by the action of the heat of the hot plate 54, the heat passing through the carrier strip 52 and the layered compound structure 24. It is noted that, instead of the hot plate 54, other heat sources may also be used, such as a source for infrared radiation, which is above the layer 62.

Under the action of heat, the polyurethane composition of the layer 62 reacts to completion and forms the core 18, on which an adhesive is applied. In the present case, the adhesive is atomized by means of a turntable 66 and distributed radially over the upper side of the layer 62.

Subsequently, the fiber mat sheet 58 is placed on the upper side of the core 18 and glued to it. The fiber mat material 58 is unwound from a roll and placed on the core in such a manner, that the barrier layer 22 is at the bottom, that is, facing the core 18. The barrier layer 22 prevents the adhesive, which creates the bond between the core 18 and the fiber match sheet 58, from being able to penetrate between the fibers of the fiber mat sheet 58. The fiber mat sheet 58 may, for example, be a nonwoven or a woven fabric sheet.

The sheet, which is produced by the steps described above, is separated into floor panels 10 by being divided in the transverse direction; subsequently, the floor panels 10 may be provided at two opposite outer edges with profiling by milling.

For this embodiment of the method of producing a floor panel 10, the use side is at the bottom and the back of the floor panel 10 is turned upward.

The polyurethane for forming the layer 62 of the core 18, may also be obtained in the present case from a polyester polyol of renewable raw materials and an aromatic isocyanate. The decorative layer 14 of the layered compound structure 24 may, in turn, also consist of fiber paper, which is impregnated with polyurethane, and the wear-resistant use layer 12 may consist of a polyurethane, which is obtained from a polyol and an aliphatic isocyanate.

What is claimed is:

1. A floor panel comprising:
a dimensionally stable core of polyurethane,
a layered compound structure disposed on the core,
a fiber mat coated on a back of the floor panel, the fiber mat including fibers which are formed by a material selected from the group consisting of glass, PET, PP, polyester and renewable raw materials, and
a barrier layer which seals the fiber mat on a side thereof facing the core.

2. The floor panel of claim 1, wherein the fibers form a nonwoven product.

3. The floor panel of claim 1, wherein the fibers are interwoven with one another to form a fabric mat.

4. The floor panel of claim 1, wherein the fiber mat is glued to a back of the core.

5. The floor panel of claim 1, wherein the barrier layer is formed from a material selected from the group consisting of polyolefin, polyethylene terephthalate (PET), polyamide (PA) and thermoplastic polyurethane (TPU).

6. The floor panel of claim 1, wherein the core comprises a polyurethane, which is obtained from a polyester polyol from renewable raw materials and an aromatic isocyanate.

7. The floor panel of claim 1, wherein the layered compound structure comprises:
at least one decorative layer, which includes a fiber paper, which is impregnated with polyurethane,
a wear-resistant layer, which rests on a side of the decorative layer averted from the core and includes a polyurethane, which is obtained from a polyol and an aliphatic isocyanate, and
a fiberglass mat.

8. The floor panel of claim 1, wherein the floor panel is profiled at least at two opposite outer edges thereof.

9. The floor panel of claim 1, wherein the core contains fillers for increasing the weight of the floor panel.

10. A method for the production of a floor panel according to claim 1, comprising the steps of:
a) depositing a fiber mat sheet which is formed from a material selected from the group consisting of fibers of glass, PET, PP, polyester and renewable raw materials, and sealed on one side by a barrier layer, on a carrier strip in such a manner, that the barrier layer is at a top thereof;
b) applying a layer of a polyurethane composition on the fiber mat sheet for forming the core, with the fiber mat composition including polyurethane and optionally fillers;
c) applying an adhesive on an upper side of the core;
d) gluing a sheet-shaped layered compound structure on the upper side of the core, which is provided with adhesive; and
e) cutting the sheet, produced in step d), into floor panels.

11. A method for producing a floor panel according to claim 1, comprising the steps of:
a′) depositing a sheet-shaped layered compound structure on a carrier strip;
b′) applying a layer of a polyurethane composition on the sheet-shaped layered compound structure for forming the core, which polyurethane composition includes polyurethane and optionally fillers;
c′) applying an adhesive on an upper side of the core; and
d′) gluing a fiber mat sheet, which is formed from a material selected from the group consisting of fibers of glass, PET, PP, polyester and renewable raw materials, and sealed on one side by a barrier layer on an upper side of the core, which is provided with adhesive, in such a manner, that the barrier layer is at a bottom thereof; and
e′) cutting the sheet, produced in step d′), into floor panels.

12. The method of claim 10, further comprising the step of supplying heat at least one of during and after step c) to the polyurethane composition layer for forming the core.

13. The method of claim 10, wherein the fiber mat sheet is a nonwoven mat.

14. The method of claim 10, wherein the fiber mat sheet is a woven fabric sheet.

15. The method of claim 10, wherein, after step e), the resulting floor panels are profiled at least at two opposite outer edges thereof.

16. The method of claim 11, further comprising the step of supplying heat at least one of during and after step c′) to the polyurethane composition layer for forming the core.

17. The method of claim 11, wherein the fiber mat sheet is a nonwoven mat.

18. The method of claim 11, wherein the fiber mat sheet is a woven fabric sheet.

19. The method of claim 11, wherein, after step e′), the resulting floor panels are profiled at least at two opposite outer edges thereof.
